(19) United States
(12) Patent Application Publication
(10) Pub. No.: US 2025/0373277 A1
(43) Pub. Date: Dec. 4, 2025

(54) NOVEL DOUBLE-LAYER WATERPROOF STRUCTURE FOR PHONE CASES

(71) Applicant: Zhiwei Wu, Gaozhou (CN)

(72) Inventor: Zhiwei Wu, Gaozhou (CN)

(21) Appl. No.: 18/759,766

(22) Filed: Jun. 28, 2024

(30) Foreign Application Priority Data
Jun. 4, 2024 (CN) 2024107165935

(51) Int. Cl. H04B 1/3888; H04B 1/38

(52) U.S. Cl. CPC H04B 1/3888; H04B 2001/3894

(57) ABSTRACT

A double-layer waterproof structure for phone cases is disclosed, including a bottom case, a face case, and a sealing ring. A first slot is provided on a top of the bottom case, a first recess is provided on a bottom of the face case, and the sealing ring is fixed in the first recess. The bottom of the face case is snapped into the first slot, a bottom of the sealing ring is against a bottom of the first slot, and the bottom of the sealing ring is provided with double-layer protrusions. Through designing of the double-layer protrusions, the sealing ring will be squeezed and deformed to a greater extent after the bottom case and the face case are snapped together, to avoid the sealing ring from being loosened after the phone case is repeated disassembly and assembly, thus preventing water leakage due to poor sealing.

### TECHNICAL FIELD

The present application relates to the technical field of cell phone accessories, and in particular to a novel double-layer waterproof structure for phone cases.

### BACKGROUND

Cell phone is one of indispensable portable products in people's daily life in contemporary society, and with continuous progress of science and technology, continuous development of society and continuous improvement of people's living standard, the cell phone has become an all-around product integrating functions such as text messaging, video call, video playback, office memo, internet access, game terminal and so on.

In real life, during use of the cell phone, it will face some extreme environment, such as use of the cell phone in rainy days, or when a user is swimming or diving with the cell phone, there will be a hidden danger of water ingress. Although there have appeared some phone cases with waterproof function on the market, most of these phone cases adopt a technical concept of single-layer waterproof structure, that is, through a single smooth sealing ring for waterproofing. Therefore, after the user uses the phone cases for a long time, especially after repeated disassembly, the sealing ring is easy to loosen, which will directly affect its sealing performance and lose its waterproof function.

In view of this, the present disclosure proposes a novel double-layer waterproof structure for phone cases.

### SUMMARY

The present disclosure aims to provide a novel double-layer waterproof structure for phone cases to address problems of a sealing ring being easily loosened after repeated disassembling by the user uses the phone cases for a long time in existing technologies.

To achieve above objectives, the present disclosure adopts following technical solutions. In some embodiments of the present disclosure, a novel double-layer waterproof structure for phone cases is provided, including a bottom case, a face case, and a sealing ring. Herein a first slot is provided on a top of the bottom case, a first recess is provided on a bottom of the face case, and the sealing ring is fixed in the first recess. The bottom of the face case is snapped into the first slot, a bottom of the sealing ring is against a bottom of the first slot, and the bottom of the sealing ring is provided with double-layer protrusions.

Preferably, a second recess is provided on the bottom of the first slot, and bottoms of the double-layer protrusions are snapped into the second recess.

Preferably, the sealing ring has first bumps integrally molded in an inner wall thereon, and the first bumps are against a sidewall of the first slot.

Preferably, the first slot is provided with second bumps, and a sidewall of the sealing ring is against sidewalls of the second bumps.

Preferably, a sealed cap is integrally molded on one side of the sealing ring.

Preferably, a strip is provided on the sidewall of the first slot, and a second slot is provided on a sidewall of the face case, and the strip is snapped into the second slot.

Preferably, the strip and a bottom of the second slot are provided with an inclined plane.

Compared with the existing technologies, the novel double-layer waterproof structure for phone cases of the present disclosure has at least following beneficial effects and advantages.
1. The novel double-layer waterproof structure for phone cases of the present disclosure, by setting double-layer protrusions at the bottom of the sealing ring, for manufacturing enterprises, it can effectively reduce defective products in the production process and improve the yield rate. For users, through designing of the double-layer protrusions, the sealing ring will be squeezed and deformed to a greater extent after the bottom case and the face case are snapped together, and a friction between the sealing ring and the bottom of the first slot will also increase, to avoid the sealing ring from being loosened after the phone case is repeated disassembly and assembly, thus preventing water leakage due to poor scaling.
2. The novel double-layer waterproof structure for phone cases of the present disclosure, when the bottom case and the face case are snapped together, bottoms of the double-layer protrusions are snapped into corresponding second recess, and the sidewalls of the protrusions are against the second recess, increasing the sealing area as well as the friction area, which further enhances the sealing and also further prevents the sealing ring from loosening.
3. The novel double-layer waterproof structure for phone cases of the present disclosure, through designing of layers, which allows for a larger trapezoidal cross-section of the double-layer protrusions and the second recess, ensuring a tight seal while taking into account the stability of the protrusions being better snapped into the second recess.

### BRIEF DESCRIPTION OF THE DRAWINGS

FIG. 1 shows a structural schematic diagram of a novel double-layer waterproof structure for phone cases in accordance with some embodiments of the present disclosure.

FIG. 2 shows another structural schematic diagram of the novel double-layer waterproof structure for phone cases in accordance with some embodiments of the present disclosure.

FIG. 3 shows still another structural schematic diagram of the novel double-layer waterproof structure for phone cases in accordance with some embodiments of the present disclosure.

FIG. 4 shows a front view of the novel double-layer waterproof structure for phone cases in accordance with some embodiments of the present disclosure.

FIG. 5 shows an enlarged view of portion A in FIG. 4.

FIG. 6 shows a structural schematic diagram of a strip of the novel double-layer waterproof structure for phone cases in accordance with some embodiments of the present disclosure.

FIG. 7 shows a structural schematic diagram of a first slot of the novel double-layer waterproof structure for phone cases in accordance with some embodiments of the present disclosure.

FIG. 8 shows an enlarged view of portion B in FIG. 7.

FIG. 9 shows a structural schematic diagram of a bottom case of the novel double-layer waterproof structure for phone cases in accordance with some embodiments of the present disclosure.

FIG. 10 shows a structural schematic diagram of a sealing ring of the novel double-layer waterproof structure for phone cases in accordance with some embodiments of the present disclosure.

In the drawings, reference signs are as follows. 1. Bottom case, 2. Face case, 102. Panel, 2. Sealing ring, 201. First slot, 202. First recess, 3. Double-layer protrusions, 301. Second recess, 4. Strip, 401. Second slot, 402. Inclined plane, 5. First bump, 501. Sealed cap, 502. Second bump.

### DETAILED DESCRIPTION OF THE EMBODIMENTS

The technical solutions in the embodiments of the present disclosure will be clearly and completely described below in conjunction with accompanying drawings in the embodiments of the present disclosure. It is obvious that the embodiments described are only a part of the embodiments of the present disclosure, and not all of the embodiments.

In the description of the present disclosure, it is to be understood that the terms “up”, “down”, “front”, “back”, “left”, “right”, “top”, “bottom”, “inner” and “outside” and the like indicate orientations or positional relationships are based on those shown in the accompanying drawings, and are intended only to facilitate the description of the present invention and to simplify the description, but not intended to indicate or imply that a device or an element referred to must have a particular orientation, be constructed and operated with a particular orientation, and therefore are not to be construed as a limitation of the present invention.

### Embodiments

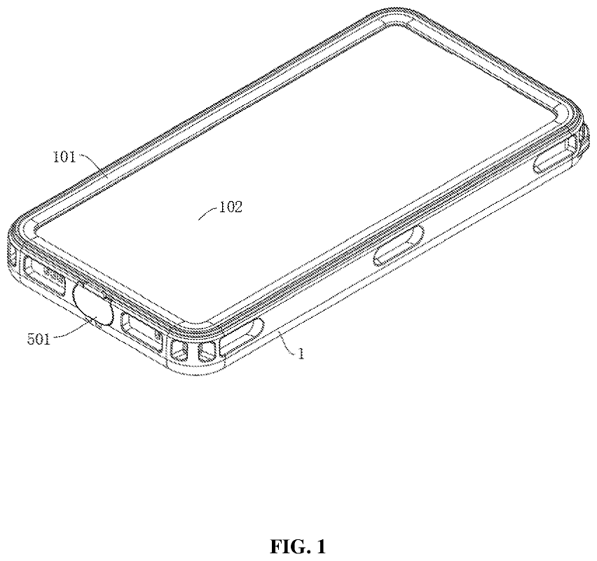

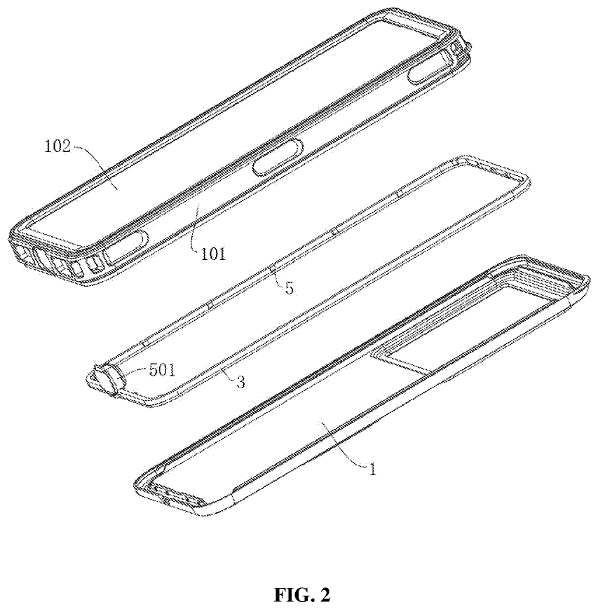

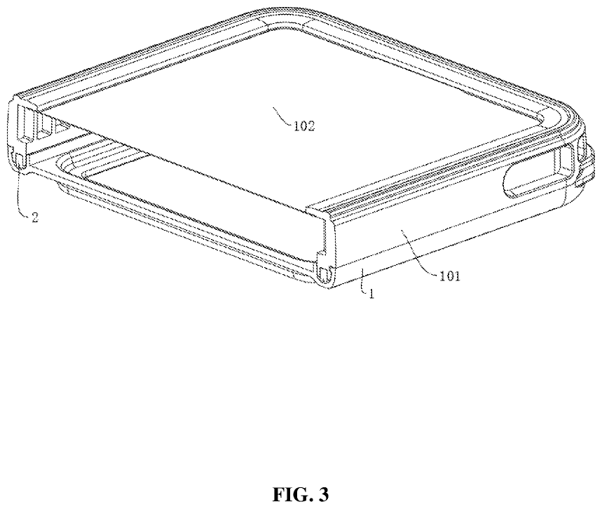

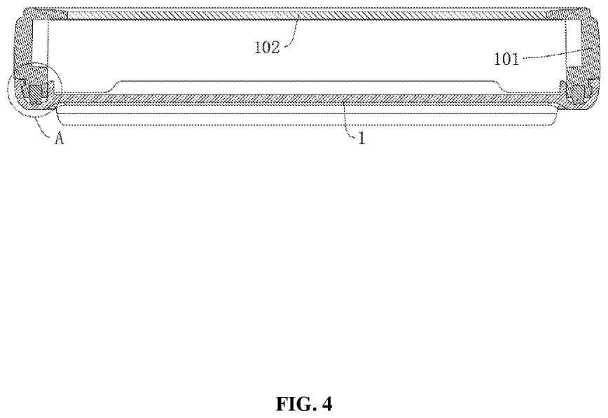

As shown in FIG. 1 to FIG. 10, in some embodiments of the present disclosure, a novel double-layer waterproof structure for phone cases is provided, including a bottom case 1 and a face case 101. Herein the bottom case 1 and the face case 101 are made of plastic, and the face case 101 is provided with a transparent panel 102 used for displaying contents. Thus a cell phone can be operated by the face case 101, for example, buttons on both sides of the cell phone, can be operated by pressed the face case 101.

In some embodiments of the present disclosure, the novel double-layer waterproof structure for phone cases further includes a scaling ring 2. A first slot 201 is provided on a top of the bottom case 1, a first recess 202 is provided on a bottom of the face case 101, and the sealing ring 2 is fixed in the first recess 202. Fixed by glue, when the sealing ring 2 is fixed in the first recess 202, a bottom of the sealing ring 2 extends out of the first recess 202, and the bottom of the face case 101 is snapped into the first slot 201. The bottom of the sealing ring 2 is against the bottom of the first slot 201, and the bottom of the sealing ring 2 is provided with double-layer protrusions 3.

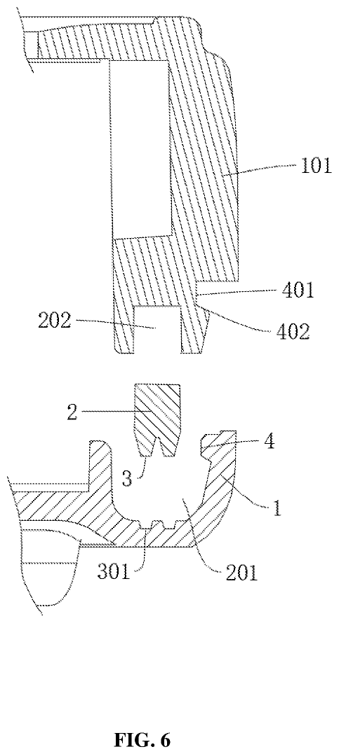

The double-layer protrusions 3, referring to FIG. 6, are trapezoidal shapes that extend downward, that is, gaps are formed between two adjacent layers of the double-layer protrusions 3.

In a process of use, when the bottom case 1 and the face case 101 snap together, the sealing ring 2 will be squeezed and then deformed, at this time the double-layer protrusions 3 having trapezoidal-shaped will be deformed to the gaps between two sides. Thus compared to traditional smooth sealing rings, the sealing ring 2 adopted in the double-layer waterproof structure for phone cases of the present disclosure can withstand a greater extrusion pressure, and deformation that occurs when it is subjected to the same extrusion pressure is also larger. Moreover, a contact point between each protrusion 3 and the bottom of the first slot 201 is equivalent to a layer of waterproof structure, and contact points between the double-layer protrusions 3 and the bottom of the first slot 201, which in turn plays a double-layer waterproofing effect, avoiding problems of easy water leakage of the traditional smooth sealing rings due to poor sealing after repeated disassembling and assembling a phone case for many times.

By setting the double-layer protrusions 3 at the bottom of the sealing ring 2, for manufacturing enterprises, it can effectively reduce defective products in the production process and improve yield rate, because even if there is a problem with one of the layers of the protrusions 3, but the other layer of the protrusions 3 still can serve the purpose of waterproofing, which increases design concept of fault tolerance. And for users, through designing of the double-layer protrusions 3, the sealing ring 3 will be squeezed and deformed to a greater extent after the bottom case 1 and the face case 101 are snapped together, and a friction between the sealing ring 2 and the bottom of the first slot 201 will also increase, to avoid the sealing ring 2 from being loosened after the phone case is repeated disassembly and assembly, thus preventing water leakage due to poor sealing.

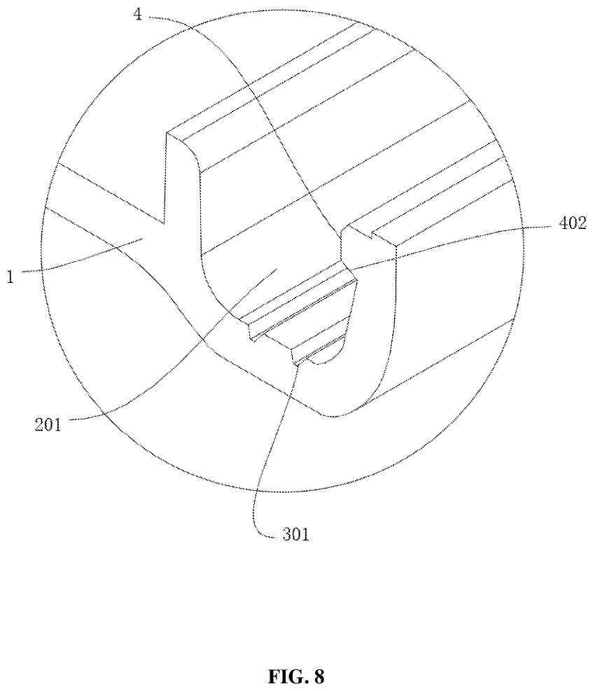

Referring to FIG. 6 and FIG. 8, a second recess 301 is provided on the bottom of the first slot 201, and the number of the second recess 301 is the same as the number of the double-layer protrusions 3.

Due to sections of the double-layer protrusions 3 and the second recess 301 are trapezoidal, the first slot 201 is synchronized to play a guiding role during a snap-fit process, and the double-layer protrusions 3 will be directly snapped into the second recess 301 when the bottom case 1 and the face case 101 are snapped together. And even if some deviation occurs, through trapezoidal bevels, the double-layer protrusions 3 will move into the second recess 301 when the sealing ring 2 is stressed.

When the bottom case 1 are snapped with the face case 101, the bottoms of the double-layer protrusions 3 are snapped into corresponding second recess 301, and sidewalls of the double-layer protrusions 3 are against the second recess 301, which can improve the sealing area as well as the friction area, and further improve sealing, thereby preventing the scaling ring 2 from loosening.

The number of the double-layer protrusions 3 is 2 layers, and by designing of 2layers, the trapezoidal cross-section of the double-layer protrusions 3 and the second recess 301 can be made larger, which ensures the sealing and meanwhile takes into account the stability of the protrusions 3 for better snap-fit into the second recess 301.

The sealing ring 2 is integrally molded with the protrusions 3 and is made of rubber.

The bottom of the sealing ring 2, by designing is as a double-layer structure, i.e., the double-layer protrusions 3, thus the sealing ring 2 will not easily fall off when strengthening the sealing ring and meanwhile disassembling the cell phone.

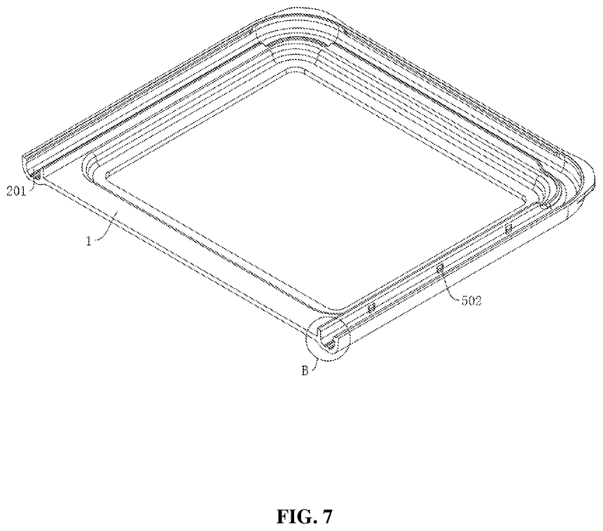

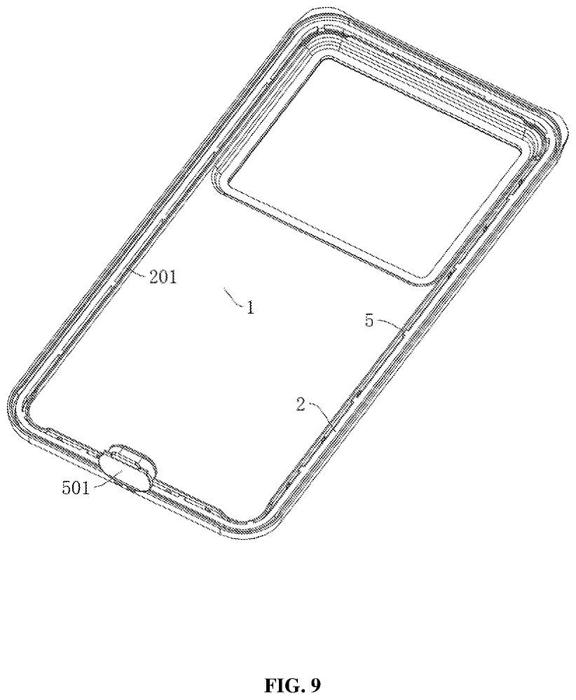

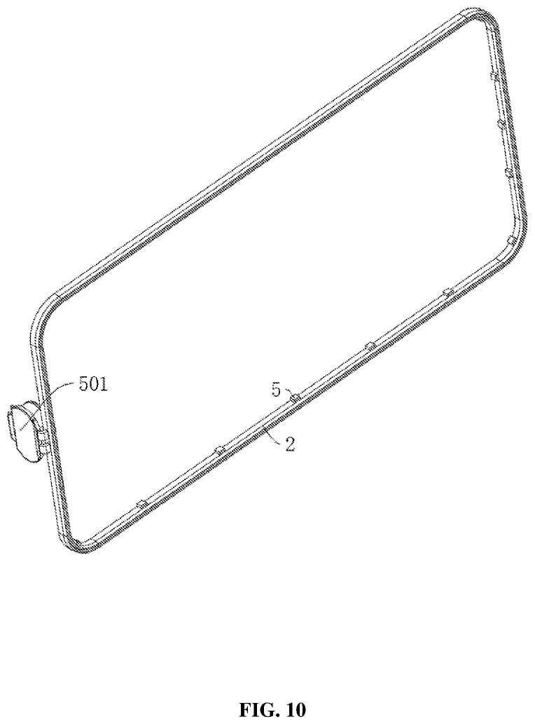

Referring to FIG. 9 and FIG. 10, the sealing ring 2 is integrally molded with first bumps 5 on an inner wall thereon, the number of the first bumps 5 is 5-10, they are evenly distributed around the inner wall of the sealing ring 2, and the sealing ring 2 abuts against the sidewall of the first slot 201 through the first bumps 5. Referring to FIG. 7, the first slot 201 is provided with second bumps 502 on a sidewall thereon, and the number of the second bumps 502 is 5-10, they are evenly distributed around the sidewall of the first slot 201, and the sidewall of the sealing ring 2 is against the sidewall of the second bumps 502.

The inner wall of the face case 101 is provided with a sliding groove, the second bumps 502 is fixed in the sliding groove when snap-fitting, which can avoid interference and at the same time serve as a guide.

The first bumps 5 are made of rubber, and the second bumps 502 are made of plastic.

When the face case 101 is snapped onto the bottom case 1, the first bumps 5 and the second bumps 502 can be used to make the sealing ring 2 and the sidewall of the first slot 201 are abutted, avoiding loosening of the scaling ring 2, thereby improving the stability after snap-fitted.

Referring to FIG. 1, FIG. 9, and FIG. 10, a sealed cap 501 is integrally molded on one side of the sealing ring 2.

After the face case 101 is snapped onto the bottom case 1, when the cell phone is no charging, the sealed cap 501 can be plugged in a charging hole to avoid water ingress.

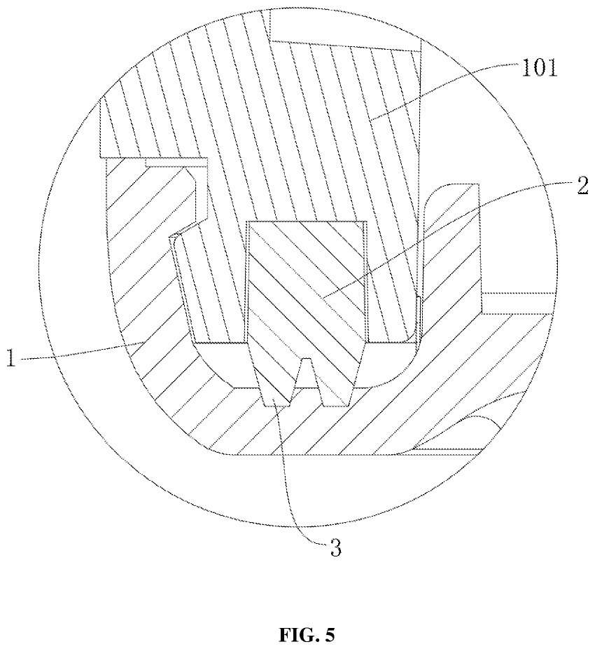

Referring to FIG. 5 and FIG. 6, a strip 4 is provided on the sidewall of the first slot 201, a second slot 401 is provided on a sidewall of the face case 101, and the strip 4 is snapped into the second slot 401.

In a snap-fitting process of the face case 101 onto the bottom case 1, the sidewall of the first slot 201 will be deformed by force firstly, and then the strip 4 will be snap-fitted in the second slot 401, avoiding accidental dislodgement of the face case from the bottom case 1 when in use, and meanwhile which also plays a role of preventing the face case 101 and the bottom case 1 from shaking, thereby improving the sealing.

The strip 4 and a bottom of the second slot 401 are provided with an inclined plane 402, and the inclined plane 402 is inclined downwardly to play the purpose of easy disassembly.

The forgoing is only some preferred specific embodiments of the present disclosure, but the scope of protection of the present invention is not limited thereto. Any skilled person familiar with technical fields in the art within the technical scope disclosed in the present disclosure, make equivalent substitutions or changes in accordance with the technical solutions and concept of the present disclosure, shall be covered within the scope of protection of the present invention.

What is claimed is:

1. A novel double-layer waterproof structure for phone cases, comprising a bottom case, a face case, and a sealing ring;
wherein a first slot is provided on a top of the bottom case, a first recess is provided on a bottom of the face case, and the sealing ring is fixed in the first recess;
wherein the bottom of the face case is snapped into the first slot; and
wherein a bottom of the sealing ring is against a bottom of the first slot, and the bottom of the sealing ring is provided with double-layer protrusions.

2. The novel double-layer waterproof structure for phone cases according to claim 1, wherein a second recess is provided on the bottom of the first slot, and bottoms of the double-layer protrusions are snapped into the second recess.

3. The novel double-layer waterproof structure for phone cases according to claim 1, wherein the sealing ring has first bumps integrally molded in an inner wall thereon, and the first bumps are against a sidewall of the first slot.

4. The novel double-layer waterproof structure for phone cases according to claim 1, wherein the first slot is provided with second bumps, and a sidewall of the sealing ring is against sidewalls of the second bumps.

5. The novel double-layer waterproof structure for phone cases according to claim 1, wherein a sealed cap is integrally molded on one side of the sealing ring.

6. The novel double-layer waterproof structure for phone cases according to claim 3, wherein a strip is provided on the sidewall of the first slot, and a second slot is provided on a sidewall of the face case; and
wherein the strip (4) is snapped into the second slot.

7. The novel double-layer waterproof structure for phone cases according to claim 6, wherein the strip and a bottom of the second slot are provided with an inclined plane.
